(19) United States
(12) Patent Application Publication
(10) Pub. No.: US 2022/0026774 A1
(43) Pub. Date: Jan. 27, 2022

(54) ELECTROCHROMIC MIRROR CONTROL DEVICE

(71) Applicant: MEEKYUNGTEC CO., LTD, Gyeonggi-do (KR)

(72) Inventors: Seung Zu YOUNG, Gyeonggi-do (KR); Jung Seok YOON, Gyeonggi-do (KR)

(21) Appl. No.: 17/296,727

(22) PCT Filed: Nov. 25, 2019
(86) PCT No.: PCT/KR2019/016213

§ 371 Date: May 25, 2021

(51) Int. Cl. G02F 1/163; G02F 1/133; B60R 1/12; B60R 1/08; B60R 1/00

(52) U.S. Cl. CPC G02F 1/163; G02F 1/13312; B60R 2001/1223; B60R 1/088; B60R 1/006; B60R 1/1207

(57) ABSTRACT

A control device of an ECM employs a current control method in place of a voltage control method in order to remove heat generation, and can stably provide a desired current and voltage to an ECM regardless of an input voltage. The control device of an ECM may include: an illuminance sensor unit configured to sense the brightness of light; an MCU configured to output a control signal corresponding to the brightness level of the sensed light; an ECM control unit configured to generate and output a constant current having a current value adjusted to correspond to the brightness level of the sensed light, in response to the control signal; and an ECM including a material to cause a chemical change in which the color thereof changes while the material is oxidized by the constant current, and having reflectivity adjusted to correspond to the adjusted current value of the constant current.

### TECHNICAL FIELD

The present disclosure relates to a control device of an ECM (Electro-Chromic Mirror) used for a vehicle.

### BACKGROUND ART

During nighttime driving, a glare from the headlight of a vehicle acts as a factor that disturbs a driver's view, and thus threatens a vehicle's safe driving. Therefore, in order to remove such a glare, an ECM is applied as a rear-view mirror or side-view mirror of a vehicle.

FIG. 1 is a schematic view illustrating a conventional control circuit of an ECM used for a vehicle.

Referring to FIG. 1, reference numeral 15 represents the state in which the ECM is not activated, and reference numeral 16 represents the state in which the ECM is activated. The ECM is activated according to electric charges stored in a condenser 17.

When the ECM is not activated, the ECM exhibits a typical characteristic of a mirror, i.e., a reflecting characteristic. On the other hand, when the ECM is activated, the ECM exhibits the non-reflecting characteristic.

When a control circuit 11 receives a sensing signal from a light sensing circuit 12, it turns on a charging circuit 13 to charge the condenser 17. When no sensing signal is received from the light sensing circuit 12, the control circuit 11 turns on a discharging circuit 14 to discharge the condenser 17.

FIG. 2 illustrates an example of a voltage drop circuit used in a control circuit for controlling a conventional ECM used for a vehicle.

Referring to FIG. 2, reference numeral 21 represents a condenser in which electric charges to activate the ECM are stored. When a charge driving circuit 23 is turned on, electric charges from a power supply VDDE are dropped by a resistor Rlim, and then stored in the condenser 21. Furthermore, when a discharge driving circuit 24 is turned on, the electric charges stored in the condenser 21 are discharged.

When the control circuit for controlling the conventional ECM used for a vehicle receives a voltage used for an electric module from a battery of the vehicle, the control circuit drops the voltage using the resistor Rlim, and then uses the dropped voltage. When the voltage (e.g. 13V or 24V) of a vehicle battery is dropped to a level of driving voltage (e.g. 1.4V) of the ECM, power consumption is increased as a large voltage drop occurs in the resistor Rlim. That is, when a battery voltage of 13V in a vehicle is dropped to the driving voltage (1.4V) of the ECM, a voltage of 11.6V needs to be dropped through the resistor Rlim. Thus, while a large power loss occurs, a large amount of heat is generated from the resistor Rlim. In this case, since a large amount of heat is locally generated in a very small place due to the voltage drop, a heat sink for dissipating the heat needs to be installed. Furthermore, a resistor capable of tolerating a high voltage is required to significantly drop a voltage through the resistor.

Such a voltage drop by the resistor makes it difficult to perform circuit design, and the installation of the heat sink increases the size of the electrical module. Furthermore, when the battery voltage of the vehicle is changed, it is difficult to drop the voltage to a voltage suitable for the ECM.

Furthermore, since the conventional ECM is activated by a voltage control method, it need time to supply a stable current to the condenser.

### DISCLOSURE

### Technical Problem

Various embodiments are directed to a control device for controlling an ECM, which employs a current control method in place of a voltage control method in order to avoid heat generation, and can stably provide a desired current and voltage to the ECM regardless of an input voltage.

### Technical Solution

In an embodiment, a control device for controlling an ECM may include: an illuminance sensor unit configured to sense the brightness of light; an MCU (Micro Controller Unit) configured to output a control signal corresponding to a level of the brightness of the sensed light; an ECM control unit configured to generate and output a constant current having a current value that is adjusted to correspond to the brightness level of the sensed light, in response to the control signal; and an ECM including a material to cause a chemical change in which the color thereof changes by oxidizing the material with the constant current outputted from the ECM control unit, and having reflectivity that is adjusted to correspond to the adjusted current value of the constant current.

The control signal may include an on/off signal for turning on/off the ECM control unit, and a control output signal for controlling the current value of the constant current, outputted from the ECM control unit, according to the brightness level of the light. The ECM control unit may include: a constant current circuit configured to block the constant current from being provided to the ECM or provide the constant current to the ECM according to the on/off signal; and a current adjusting unit configured to adjust the current value of the constant current provided to the ECM from the constant current circuit, based on the control output signal. When receiving only the on signal, the constant current circuit may output the constant current having the maximum current value to minimize the reflectivity of the ECM. The constant current circuit may output the constant current having a current value that is adjusted by the current adjusting unit so as to correspond to the brightness level of the light, when receiving the on signal. When receiving the off signal, the constant current circuit may maximize the reflectivity of the ECM. The illuminance sensor unit may include: a front illuminance sensor configured to sense the day and night; and a rear illuminance sensor configured to sense light from the headlight of a rear vehicle.

### Advantageous Effects

In accordance with the embodiment of the present disclosure, the control device for controlling the ECM may employ a current control method in place of a voltage control method in order to avoid heat generation, and can stably provide a desired current and voltage to the ECM regardless of an input voltage.

### BRIEF DESCRIPTION OF DRAWINGS

FIG. 1 is a schematic view illustrating a conventional control circuit for controlling an ECM used for a vehicle.

FIG. 2 illustrates an example of a voltage drop circuit used in a control circuit for controlling a conventional ECM for a vehicle.

FIG. 3 is a block diagram illustrating a control device for controlling an ECM used for a vehicle in accordance with an embodiment of the present disclosure.

FIG. 4 is a flowchart illustrating a control method of an ECM used for a vehicle in accordance with an embodiment of the present disclosure.

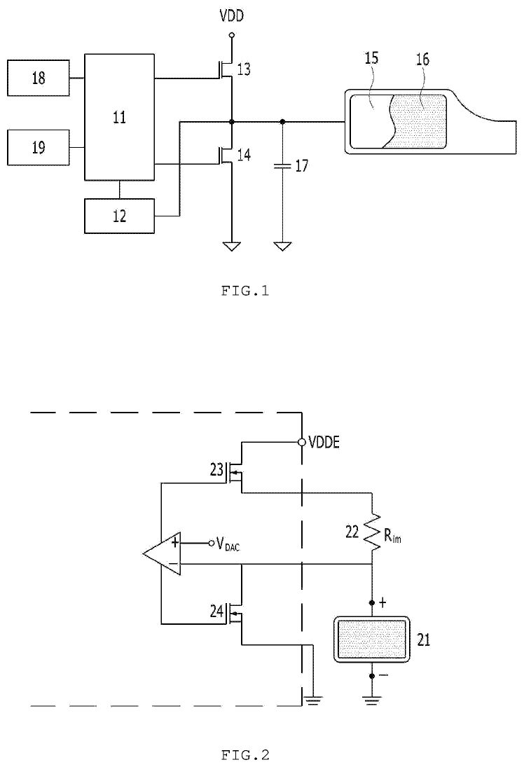

### MODE FOR INVENTION

The above-described purposes, features and advantages will be clarified through the detailed descriptions to be described below in detail with reference to the accompanying drawings. Thus, the technical idea of the present disclosure can be easily carried out by those skilled in the art to which the present disclosure pertains. Furthermore, in describing the present disclosure, detailed descriptions for publicly known technologies related to the present disclosure will be ruled out in order not to unnecessarily obscure subject matters of the present disclosure.

Throughout the specification, when one element is referred to as being “connected to” or “coupled to” another element, it may indicate that the one element is “directly connected or coupled to” the another element or the one element is “electrically connected or coupled to” with still another element interposed therebetween. Furthermore, when an element “includes” or “has” a component, it may indicate that the element does not exclude another component unless referred to the contrary, but can further include another component. In addition, through the specification, the present disclosure is not limited by the expressions in a singular form for some components, and the expressions may include the expressions in a plural form unless referred to the contrary.

Electrochromism refers to the phenomenon where the color of a material is changed by an oxidation-reduction reaction when electricity is allowed to flow through the material. An ECM (Electro-Chromic Mirror) refers to a device that causes a chemical change when an electrical signal is applied from the outside, based on the principle of the electrochromism. Specifically, the color of the ECM changes while reactants are moved by an oxidation-reduction reaction. For example, the ECM may automatically sense strong light from another vehicle which is cast on a vehicle mirror in the daytime or nighttime, and simultaneously change the color thereof to adjust the reflectivity thereof, thereby stably protecting a driver's view.

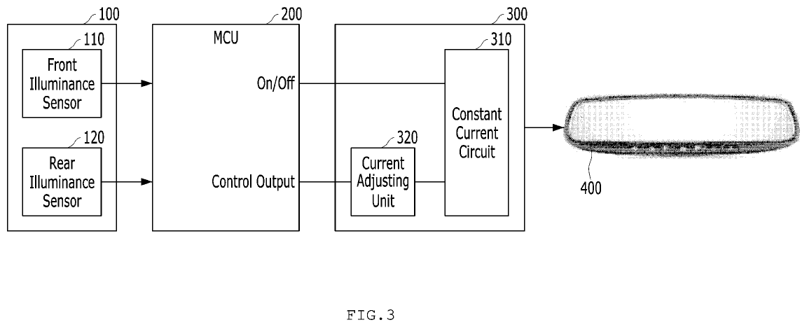

FIG. 3 is a block diagram illustrating a control device of an ECM for a vehicle in accordance with an embodiment of the present disclosure.

As illustrated in FIG. 3, the control device of the ECM in accordance with the present embodiment may include an illuminance sensor unit 100 and an MCU (Micro Controller Unit) 200. The illuminance sensor unit 100 may sense the brightness of light, and the MCU 200 may output a control signal corresponding to a level of the brightness of light sensed by the illuminance sensor unit 100. The control device may further include an ECM control unit 300 and an ECM 400. The ECM control unit 300 may generate and output a constant current having a current value that is adjusted to correspond to the brightness level of the sensed light, in response to the control signal, and the ECM 400 may include a material to causes a chemical change, and have reflectivity that is adjusted to correspond to the adjusted current value of the constant current. For example, the material may be oxidized by the constant current outputted from the ECM control unit 300, thereby causing the color change.

The illuminance sensor unit 100 may sense light and generate an electrical signal. At this time, the generated electrical signal may be an analog voltage of 0V to 3.3V. The illuminance sensor unit 100 may include a front illuminance sensor 110 configured to sense the day and night, and a rear illuminance sensor 120 configured to sense light from the headlight of a rear vehicle.

The MCU 200 may comprise a micro controller unit to perform a function of a signal processing control unit. The MCU may be implemented as a microprocessor, microcontroller, digital signal processor or programmable logic unit. The MCU 200 may perform an analog-digital conversion function of converting an analog signal inputted from the illuminance sensor unit 100 into a digital signal.

The MCU 200 may provide an on/off signal and a control output signal to the ECM control unit 300. The on/off signal may turn on/off the ECM control unit 300 according to the brightness level of light sensed by the illuminance sensor unit 100, and the control output signal may control the current value of the constant current, outputted from the ECM control unit 300, according to the brightness level of the light. The control output signal may include a PWM (Pulse Width Modulation) signal and a DAC (Digital-to-Analog Convert) signal.

The ECM control unit 300 may include a constant current circuit 310 and a current adjusting unit 320. The constant current circuit 310 may block a constant current to be provided to the ECM 400, or provide the constant current to the ECM 400 according to the on/off signal, and the current adjusting unit 320 may adjust the current value of the constant current provided to the ECM 400 by the constant current circuit 310, based on the control output signal.

The constant current circuit 310 may output to the ECM 400 the constant current, which has the maximum current value to minimize the reflectivity of the ECM 400.

That is, when only the on signal is outputted from the MCU 200 to drive the ECM control unit 300, the constant current having the maximum current value, set in the ECM control unit 300, may be supplied to the ECM 400 such that the materials contained in the ECM 400 all chemically react. Thus, the reflectivity of the ECM 400 may be minimized.

Furthermore, when the off signal is outputted from the MCU 200 to stop the operation of the ECM control unit 300, the materials contained in the ECM 400 do not chemically react at all. Thus, the reflectivity of the ECM 400 may be maximized.

When the control output signal is inputted to the current adjusting unit 320 with the on signal inputted to the constant current circuit 310, the constant current whose current value is adjusted by the current adjusting unit 320 so as to correspond to the brightness level of light may be outputted to the ECM 400. When the constant current whose current value is adjusted to correspond to the brightness level of the light is outputted to the ECM 400 through the ECM control unit 300, the oxidation degree of the materials contained in the ECM 400 may be varied according to the current value of the constant current. As a result, the reflectivity of the ECM 400 may be adjusted according to the brightness level of the sensed light.

The constant current circuit 310 may include a constant current circuit such as an LED driver. Besides, the constant current circuit 310 may include all applicable constant current circuits.

According to the current value of the constant current outputted from the ECM control unit 300, the ECM 400 may cause a chemical change in which the color of the materials contained therein changes by moving the materials due to an oxidation-reduction reaction. Thus, the reflectivity of the ECM 400 may be adjusted to stably protect a driver's view.

As such, the control device of the ECM in accordance with the embodiment of the present disclosure may include the constant current circuit to adjust a current value, and thus improve thermal efficiency, compared with the voltage control method which consumes a large amount of power due to a significant voltage drop. Therefore, a heat sink for dissipating heat may be omitted. Furthermore, since the control device can stably supply a desired current and voltage to the ECM regardless of an input voltage, the time required for stabilizing the current may be reduced unlike the voltage control method.

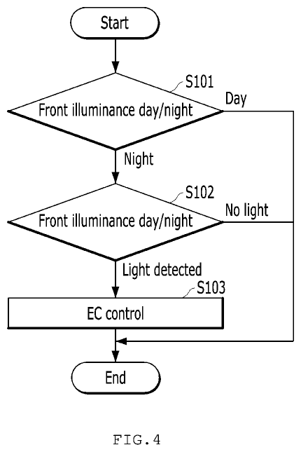

FIG. 4 is a flowchart illustrating a control method for controlling an ECM used for a vehicle in accordance with an embodiment of the present disclosure. The flowchart of FIG. 4 illustrates a control method of the control device for controlling the ECM illustrated in FIG. 3. In order to promote understandings, the same reference numerals as those of FIG. 3 are applied.

Referring to FIG. 4, the control device of the ECM in accordance with the embodiment of the present disclosure first performs step S101 in which the front illuminance sensor 110 distinguishes between the day and night. At this time, when the result value of the front illuminance sensor 110 is outputted as ‘day’, the ECM does not need to be controlled. Thus, the control device ends the control operation. That is, the MCU 200 may output the off signal to stop the operation of the ECM control unit 300, such that the materials contained in the ECM 400 do not chemically react at all. Thus, the reflectivity of the ECM 400 may be maximized.

On the other hand, when the result value of the front illuminance sensor 110 is outputted as ‘night’, the rear illuminance sensor 120 senses light from the headlight of a rear vehicle at step S102. At this time, when the result value of the rear illuminance sensor 120 indicates that no light is sensed, the ECM does not need to be controlled. Thus, the control device ends the control operation. That is, the MCU 200 may output the off signal to stop the operation of the ECM control unit 300, such that the materials contained in the ECM 400 do not chemically react at all. Thus, the reflectivity of the ECM 400 may be maximized.

On the other hand, when the result value of the rear illuminance sensor 120 indicates that light was sensed, the MCU 200 provides the ECM control unit 300 with a control signal corresponding to the brightness level of the light, at step S103. That is, the MCU 200 may provide the ‘on’ signal to the constant current circuit 310, and simultaneously provide the current adjusting unit 320 with a control output signal for adjusting the current value. Therefore, the ECM control unit 300 may provide the ECM 400 with a constant current having a current value that is adjusted to correspond to the brightness level of the sensed light, and the reflectivity of the ECM 400 may be adjusted according to the brightness level of the sensed light, thereby protecting a driver's view.

So far, the various embodiments for the problems to be solved have been described. However, it is obvious to those skilled in the art to which the present disclosure pertains that various changes and modifications can be made without departing from the technical spirit of the present disclosure.

### INDUSTRIAL APPLICABILITY

The present disclosure relates to a control device of an ECM used in a vehicle, and is applicable to industries related to the ECM.

1. A control device for controlling an ECM (Electro-Chromic Mirror), comprising:
an illuminance sensor unit configured to sense the brightness of light;
an MCU (Micro Controller Unit) configured to output a control signal corresponding to a level of the brightness of the sensed light;
an ECM control unit configured to generate and output a constant current having a current value that is adjusted to correspond to the brightness level of the sensed light, in response to the control signal; and
an ECM comprising a material to cause a chemical change in which the color thereof changes by oxidizing the material with the constant current outputted from the ECM control unit, and having reflectivity that is adjusted to correspond to the adjusted current value of the constant current.

2. The control device of claim 1, wherein the control signal comprises an on/off signal for turning on/off the ECM control unit, and a control output signal for controlling the current value of the constant current outputted from the ECM control unit, according to the brightness level of the light.

3. The control device of claim 2, wherein the ECM control unit comprises:
a constant current circuit configured to block the constant current from being provided to the ECM or provide the constant current to the ECM according to the on/off signal; and
a current adjusting unit configured to adjust the current value of the constant current provided to the ECM from the constant current circuit, based on the control output signal.

4. The control device of claim 3, wherein when receiving only the on signal, the constant current circuit outputs the constant current having the maximum current value to minimize the reflectivity of the ECM.

5. The control device of claim 3, wherein the constant current circuit outputs the constant current having a current value that is adjusted by the current adjusting unit so as to correspond to the brightness level of the light, when receiving the on signal.

6. The control device of claim 3, wherein when receiving the off signal, the constant current circuit maximizes the reflectivity of the ECM.

7. The control device of claim 1, wherein the illuminance sensor unit comprises:
a front illuminance sensor configured to sense the day and night; and
a rear illuminance sensor configured to sense light from the headlight of a rear vehicle.
